(19) United States
(12) Patent Application Publication
(10) Pub. No.: US 2025/0096904 A1
(43) Pub. Date: Mar. 20, 2025

(54) LIGHT INTENSITY MODULATION DEVICE AND WAVEFORM COMPRESSION DEVICE

(71) Applicant: Mitsubishi Electric Corporation, Tokyo (JP)

(72) Inventors: Junya NISHIOKA, Tokyo (JP); Yoshiaki KONISHI, Tokyo (JP); Seiki NAKAMURA, Tokyo (JP); Takatoshi AKAMATSU, Tokyo (JP)

(73) Assignee: Mitsubishi Electric Corporation, Tokyo (JP)

(21) Appl. No.: 18/962,715

(22) Filed: Nov. 27, 2024

Related U.S. Application Data
(63) Continuation of application No. PCT/JP2022/030511, filed on Aug. 10, 2022.

(51) Int. Cl. H04B 10/54; G02F 1/21; H04B 10/079; H04B 10/508

(52) U.S. Cl. CPC H04B 10/541; G02F 1/21; H04B 10/079; H04B 10/508

(57) ABSTRACT

A device includes: a light distributor to split a pulsed beam; a light sensor to convert a first pulsed beam split by the light distributor into an electric signal; an ADC to convert the electric signal obtained by the light sensor, which is an analog signal, into a digital signal; a correction superimposition waveform calculation unit to calculate correction superimposition waveform data which is waveform data to correct a distortion due to a temporal intensity fluctuation of a pulsed beam on the basis of superimposition waveform data and the electric signal; a DAC to convert the correction superimposition waveform data calculated by the correction superimposition waveform calculation unit, which is a digital signal, into an analog signal; and a light intensity modulator to obtain an intensity-modulated beam by superimposing the correction superimposition waveform data obtained by the DAC onto a second pulsed beam split by the light distributor.

### CROSS REFERENCE TO RELATED APPLICATION

This application is a Continuation of PCT International Application No. PCT/JP2022/030511, filed on Aug. 10, 2022, which is hereby expressly incorporated by reference into the present application.

### TECHNICAL FIELD

The present disclosure relates to a light intensity modulation device to intensity-modulate a pulsed beam, and a waveform compression device including the light intensity modulation device.

### BACKGROUND ART

There is a conventionally known device to compress a pulsed beam (e.g. see Patent Literature 1).

In the device disclosed in Patent Literature 1, a beam pulse shaping unit first shapes the light intensity waveform of a pulsed beam output by a beam source unit. Next, a compression unit compresses, using dispersion, the pulsed beam resulting from the shaping by the beam pulse shaping unit, and obtains a compressed pulsed beam.

In addition, in this device, a calculation control unit monitors the pulsed beam resulting from the shaping by the beam pulse shaping unit, and compares the pulsed beam with a target waveform, thereby computing a target value for the shaping. Then, in this device, a result of the calculation by the calculation control unit is input to the beam pulse shaping unit, and modulation control is performed, thereby obtaining a target compressed pulsed beam.

### CITATION LIST

### Patent Literatures

Patent Literature 1: JP 2013-178374 A

### SUMMARY OF INVENTION

### Technical Problem

However, Patent Literature 1 does not mention a function and object of superimposing any superimposition waveform on the compressed pulsed beam.

In addition, the intensity waveform of the pulsed beam is not an ideal shape in the pulses, and fluctuates temporally in some cases. In this case, if any superimposition waveform is superimposed on the pulsed beam described above, a distortion occurs in a modulation waveform of the pulsed beam undesirably.

The present disclosure has been made to solve the problem described above, and an object thereof is to provide a light intensity modulation device that can suppress a distortion in a modulation waveform of a pulsed beam even in a case where temporal fluctuations are generated in the intensity waveform of the pulsed beam as compared to conventional techniques.

### Solution to Problem

A light intensity modulation device according to the present disclosure includes: a light distributor to split a pulsed beam; a light sensor to convert a first pulsed beam split by the light distributor into an electric signal; an analog-to-digital converter to convert the electric signal resulting from conversion by the light sensor, which is an analog signal, into a digital signal; a correction superimposition waveform calculator to calculate correction superimposition waveform data which is waveform data representing any light intensity waveform, taking into consideration a distortion due to a temporal intensity fluctuation of a pulsed beam, on a basis of any superimposition waveform data and the electric signal resulting from conversion by the analog-to-digital converter, so that a value of the electric signal equivalent to a minimum value of the electric signal in a zone of the electric signal equivalent to a zone of the pulsed beam in which there is a possibility that a temporal intensity fluctuation has been generated in the pulsed beam, or an average value of a value of the electric signal equivalent to the minimum value becomes an upper limit value in a full-scale range of an intensity-modulated beam; a digital-to-analog converter to convert the correction superimposition waveform data calculated by the correction superimposition waveform calculator, which is a digital signal, into an analog signal; and a light intensity modulator to obtain an intensity-modulated beam having any waveform, by superimposing the correction superimposition waveform data resulting from conversion by the digital-to-analog converter onto a second pulsed beam split by the light distributor.

### Advantageous Effects of Invention

By being configured in the manner described above, the present disclosure can suppress a distortion in a modulation waveform of a pulsed beam even in a case where temporal fluctuations are generated in the intensity waveform of the pulsed beam as compared to conventional techniques.

### BRIEF DESCRIPTION OF DRAWINGS

FIG. 1 is a figure depicting a configuration example of a waveform compression device according to a first embodiment.

FIG. 2 is a figure depicting a specific configuration example of the waveform compression device according to the first embodiment.

FIG. 3 is a flowchart depicting an operation example of the waveform compression device according to the first embodiment.

FIG. 4A to FIG. 4C are figures depicting operation examples of the waveform compression device according to the first embodiment, FIG. 4A is a figure depicting examples of a pulsed beam input to an MZM and a pulsed beam biased by the MZM, FIG. 4B is a figure depicting an example of modulation characteristics of the MZM, and FIG. 4C is a figure depicting an example of a pulsed beam resulting from intensity-modulation by the MZM.

FIG. 5 is a figure depicting another configuration example of the waveform compression device according to the first embodiment.

### DESCRIPTION OF EMBODIMENTS

Hereinafter, an embodiment will be described in detail with reference to the figures.

### First Embodiment

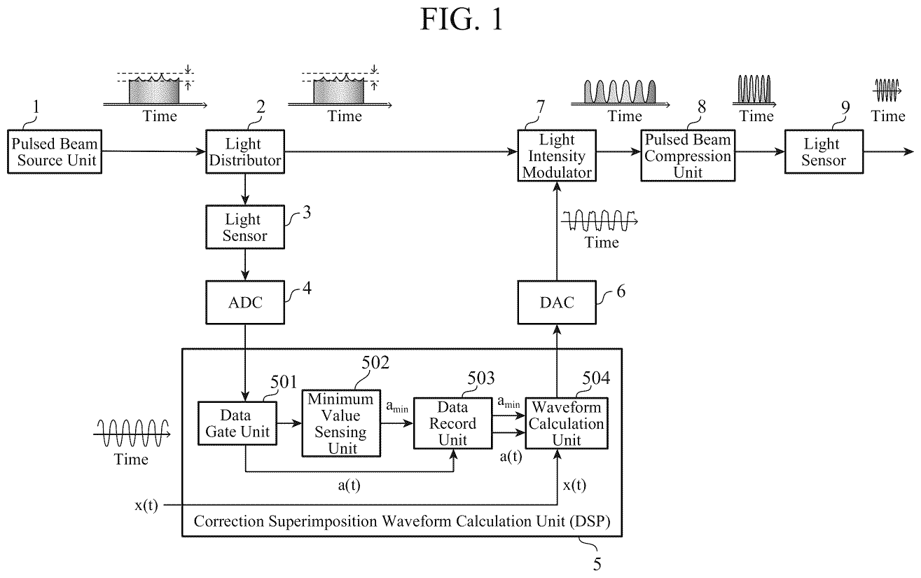

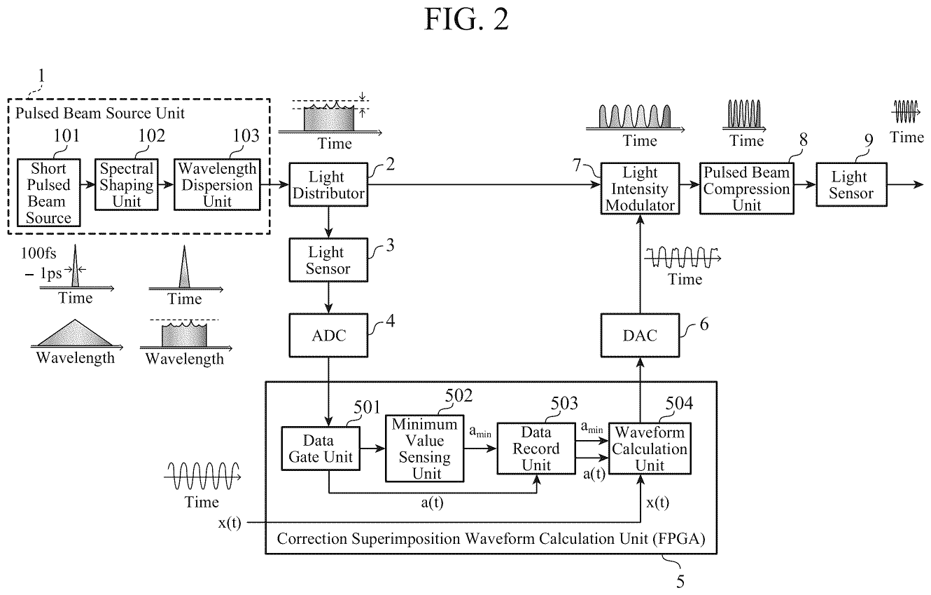

FIG. 1 is a figure depicting a configuration example of a waveform compression device according to a first embodiment. In addition, FIG. 2 is a figure depicting a specific configuration example of the waveform compression device according to the first embodiment.

As depicted in FIG. 1, the waveform compression device includes a pulsed beam source unit 1, a light distributor 2, a light sensor 3, an analog-to-digital converter (ADC) 4, a correction superimposition waveform calculation unit 5, a digital-to-analog converter (DAC) 6, a light intensity modulator 7, a pulsed beam compression unit 8, and a light sensor (second light sensor) 9.

Note that, in the waveform compression device depicted in FIG. 1, the pulsed beam source unit 1, the light distributor 2, the light sensor 3, the ADC 4, the correction superimposition waveform calculation unit 5, the DAC 6, and the light intensity modulator 7 are included in a light intensity modulation device.

The pulsed beam source unit 1 generates a pulsed beam. The pulsed beam generated by the pulsed beam source unit 1 is output to the light distributor 2.

For example, as depicted in FIG. 2, the pulsed beam source unit 1 has a short pulsed beam source 101, a spectral shaping unit 102, and a wavelength dispersion unit 103.

The short pulsed beam source 101 generates a wideband short pulsed beam. Note that, for example, the duration of the short pulsed beam generated by the short pulsed beam source 101 is approximately 100 fs to 1 ps. The short pulsed beam generated by the short pulsed beam source 101 is output to the spectral shaping unit 102.

Note that, in FIG. 2, an example of the short pulsed beam generated by the short pulsed beam source 101 is depicted in figures in two rows under a functional block representing the short pulsed beam source 101. Here, a figure in the upper row depicts the time waveform of the short pulsed beam generated by the short pulsed beam source 101. The horizontal axis represents time, and the vertical axis represents intensity. In addition, a figure in the lower row depicts the spectral waveform of the short pulsed beam generated by the short pulsed beam source 101. The horizontal axis represents wavelength, and the vertical axis represents intensity.

The spectral shaping unit 102 performs spectral shaping on the short pulsed beam generated by the short pulsed beam source 101. That is, the spectral shaping unit 102 performs the spectral shaping of the wavelength of the short pulsed beam generated by the short pulsed beam source 101 in such a manner that the waveform becomes approximately rectangular, for example, by adjusting the level of each wavelength component of the short pulsed beam. The short pulsed beam resulting from the spectral shaping by the spectral shaping unit 102 is output to the wavelength dispersion unit 103.

For example, a Wavelength Selective Switch (WSS) can be used as the spectral shaping unit 102.

Note that, in FIG. 2, an example of the short pulsed beam resulting from the spectral shaping by the spectral shaping unit 102 is depicted in figures in two rows under a functional block representing the spectral shaping unit 102. Here, a figure in the upper row depicts the time waveform of the short pulsed beam resulting from the spectral shaping by the spectral shaping unit 102. The horizontal axis represents time, and the vertical axis represents intensity. In addition, a figure in the lower row depicts the spectral waveform of the short pulsed beam resulting from the spectral shaping by the spectral shaping unit 102. The horizontal axis represents wavelength, and the vertical axis represents intensity.

The wavelength dispersion unit 103 performs waveform dispersion on the short pulsed beam resulting from the spectral shaping by the spectral shaping unit 102. That is, the wavelength dispersion unit 103 stretches the pulsed beam by adding delays according to the wavelength to the short pulsed beam resulting from the spectral shaping by the spectral shaping unit 102, and generates a stretched pulsed beam having a time waveform approximately similar to the spectral shape. The stretched pulsed beam obtained by the wavelength dispersion unit 103 is output to the light distributor 2. For example, the wavelength dispersion unit 103 obtains the stretched pulsed beam by adding delays that increase as the wavelength increases to the short pulsed beam resulting from the spectral shaping by the spectral shaping unit 102. Alternatively, the wavelength dispersion unit 103 obtains the stretched pulsed beam by adding delays that increase as the wavelength decreases to the short pulsed beam resulting from the spectral shaping by the spectral shaping unit 102.

For example, a Single Mode Fiber (SMF) can be used as the wavelength dispersion unit 103.

Note that FIG. 1 and FIG. 2 depict figures of an example of the pulsed beam (stretched pulsed beam) generated by the pulsed beam source unit 1 (wavelength dispersion unit 103) after functional blocks representing the pulsed beam source unit 1 (wavelength dispersion unit 103). These figures depict the time waveform of the pulsed beam (stretched pulsed beam) generated by the pulsed beam source unit 1 (wavelength dispersion unit 103). The horizontal axes represent time, and the vertical axes represent intensity.

Then, as depicted in FIG. 1 and FIG. 2, the intensity waveform of the pulsed beam (stretched pulsed beam) generated by the pulsed beam source unit 1 (wavelength dispersion unit 103) is not an ideal rectangular waveform due to errors in the spectral shaping, and actually is a waveform with temporal fluctuations in pulses. Note that, in each figure depicting an example of the pulsed beam (stretched pulsed beam) generated by the pulsed beam source unit 1 (wavelength dispersion unit 103), the upper broken line in two broken lines represents the maximum value of intensity fluctuations, and the lower broken line represents the minimum value of intensity fluctuations.

The light distributor 2 splits the pulsed beam generated by the pulsed beam source unit 1 into two. A first pulsed beam split by the light distributor 2 is output to the light sensor 3, and a second pulsed beam is output to the light intensity modulator 7.

For example, as depicted in FIG. 2, a light coupler can be used as the light distributor 2.

The light sensor 3 converts the first pulsed beam split by the light distributor 2 into an electric signal. The electric signal obtained by the light sensor 3 is output to the ADC 4.

For example, as depicted in FIG. 2, a Photo Diode (PD) can be used as the light sensor 3.

The ADC 4 obtains sampling data of the pulsed beam by converting the electric signal obtained by the light sensor 3, which is an analog signal, into a digital signal. The digital signal obtained by the ADC 4 is output to the correction superimposition waveform calculation unit 5.

The correction superimposition waveform calculation unit 5 calculates correction superimposition waveform data on the basis of any superimposition waveform data and the electric signal resulting from the conversion by the ADC 4. Note that the superimposition waveform data is represented by x(t). In addition, the correction superimposition waveform data is waveform data to correct a distortion due to temporal intensity fluctuations of the pulsed beam. The correction superimposition waveform data calculated by the correction superimposition waveform calculation unit 5 is output to the DAC 6.

For example, a Digital Signal Processing (DSP) configured using a Field Programmable Gate Array (FPGA) can be used as the correction superimposition waveform calculation unit 5.

Note that FIG. 1 and FIG. 2 depict figures of an example of the superimposition waveform data input to the correction superimposition waveform calculation unit 5 before functional blocks representing the correction superimposition waveform calculation unit 5. The figures depict the time waveform of the superimposition waveform data. The horizontal axes represent time, and the vertical axes represent voltage. In addition, as an example, FIG. 1 and FIG. 2 depict a case where the superimposition waveform data is data with a sine waveform.

For example, as depicted in FIG. 1 and FIG. 2, the correction superimposition waveform calculation unit 5 has a data gate unit 501, a minimum value sensing unit 502, a data record unit 503, and a waveform calculation unit 504.

The data gate unit 501 acquires, as pulse waveform data, data of a partial zone from the electric signal resulting from the conversion by the ADC 4. Note that the pulse waveform data is represented by a (t). The pulse waveform data acquired by the data gate unit 501 is output to the minimum value sensing unit 502 and the data record unit 503.

On the basis of the pulse waveform data acquired by the data gate unit 501, the minimum value sensing unit 502 senses the minimum value of the pulse waveform data. Note that the minimum value of the pulse waveform data is represented by aₘᵢₙ. Data representing the minimum value of the pulse waveform data sensed by the minimum value sensing unit 502 is output to the data record unit 503.

The data record unit 503 records the pulse waveform data acquired by the data gate unit 501, and the data representing the minimum value of the pulse waveform data sensed by the minimum value sensing unit 502.

Note that the data record unit 503 may record one piece of pulse waveform data acquired by the data gate unit 501, and the data representing the minimum value of the pulse waveform data sensed by the minimum value sensing unit 502. Alternatively, the data record unit 503 may record the pulse waveform data acquired by the data gate unit 501, and the data representing the minimum value of the pulse waveform data sensed by the minimum value sensing unit 502 while updating the pulse waveform data and the data representing the minimum value of the pulse waveform data every time or at predetermined timings. Alternatively, the data record unit 503 may record data representing a result obtained by averaging a plurality of pieces of pulse waveform data acquired by the data gate unit 501, and data representing a result obtained by averaging the minimum values of the plurality of pieces of pulse waveform data sensed by the minimum value sensing unit 502.

Note that, for example, a non-volatile or volatile semiconductor memory such as a Random Access Memory (RAM), a Read Only Memory (ROM), a flash memory, an Erasable Programmable ROM (EPROM), or an Electrically EPROM (EEPROM), or a magnetic disk, a flexible disc, an optical disc, a compact disc, a mini disc, a Digital Versatile Disc (DVD), or the like is the data record unit 503.

The waveform calculation unit 504 calculates the correction superimposition waveform data on the basis of any superimposition waveform data, and the pulse waveform data and the data representing the minimum value of the pulse waveform data recorded in the data record unit 503. At this time, it is desirable if the waveform calculation unit 504 calculates the correction superimposition waveform data on the basis of modulation characteristics of the light intensity modulator 7. The correction superimposition waveform data calculated by the waveform calculation unit 504 is output to the DAC 6.

Note that FIG. 1 and FIG. 2 depict a case where the data record unit 503 is provided inside the light intensity modulation device and the waveform compression device. However, this is not the sole example, and the data record unit 503 may be provided outside the light intensity modulation device and the waveform compression device.

The DAC 6 converts the correction superimposition waveform data obtained by the correction superimposition waveform calculation unit 5, which is a digital signal, into an analog signal. The correction superimposition waveform data by the DAC 6 is output to the light intensity modulator 7.

Note that FIG. 1 and FIG. 2 depict figures of an example of the correction superimposition waveform data generated by the DAC 6 after functional blocks representing the DAC 6. The figures depict the time waveform of the correction superimposition waveform data generated by the DAC 6. The horizontal axes represent time, and the vertical axes represent voltage.

The light intensity modulator 7 obtains an intensity-modulated beam by superimposing the correction superimposition waveform data resulting from the conversion by the DAC 6 on the second pulsed beam split by the light distributor 2, and modulating the pulsed beam. The intensity-modulated beam obtained by the light intensity modulator 7 is output to the pulsed beam compression unit 8.

For example, as depicted in FIG. 2, a Mach-Zehnder Modulator (MZM) can be used as the light intensity modulator 7. Note that it is known that, as modulation characteristics, a harmonic distortion due to overmodulation occurs in the MZM.

Note that FIG. 1 and FIG. 2 depict figures of an example of the intensity-modulated beam generated by the light intensity modulator 7 above or after functional blocks representing the light intensity modulator 7. These figures depict the time waveform of the intensity-modulated beam generated by the light intensity modulator 7. The horizontal axes represent time, and the vertical axes represent intensity.

The pulsed beam compression unit 8 obtains a compressed pulsed beam by compressing the pulsed beam modulated by the light intensity modulator 7. That is, the pulsed beam compression unit 8 compresses the pulsed beam by performing wavelength dispersion opposite to that performed by the wavelength dispersion unit 103, on the pulsed beam modulated by the light intensity modulator 7. The compressed pulsed beam obtained by the pulsed beam compression unit 8 is output to the light sensor 9.

For example, as depicted in FIG. 2, a wavelength reverse dispersion unit such as a reverse dispersion fiber can be used as the pulsed beam compression unit 8.

Note that FIG. 1 and FIG. 2 depict figures of an example of the compressed pulsed beam generated by the pulsed beam compression unit 8 above or after functional blocks representing the pulsed beam compression unit 8. These figures depict the time waveform of the compressed pulsed beam generated by the pulsed beam compression unit 8. The horizontal axes represent time, and the vertical axes represent intensity.

The light sensor 9 converts the compressed pulsed beam obtained by the pulsed beam compression unit 8 into an electric signal. Thereby, the waveform compression device can obtain an electric signal with a high frequency and a desired compressed pulse waveform. The electric signal obtained by the light sensor 9 is output to the outside of the waveform compression device.

For example, as depicted in FIG. 2, a PD can be used as the light sensor 9.

Note that FIG. 1 and FIG. 2 depict figures of an example of the electric signal generated by the light sensor 9 after functional blocks representing the light sensor 9. These figures depict the time waveform of the electric signal generated by the light sensor 9. The horizontal axes represent time, and the vertical axes represent voltage.

In addition, FIG. 1 and FIG. 2 depict a case where the pulsed beam source unit 1 is provided inside the waveform compression device and the light intensity modulation device. However, this is not the sole example, and the pulsed beam source unit 1 may be provided outside the waveform compression device and the light intensity modulation device.

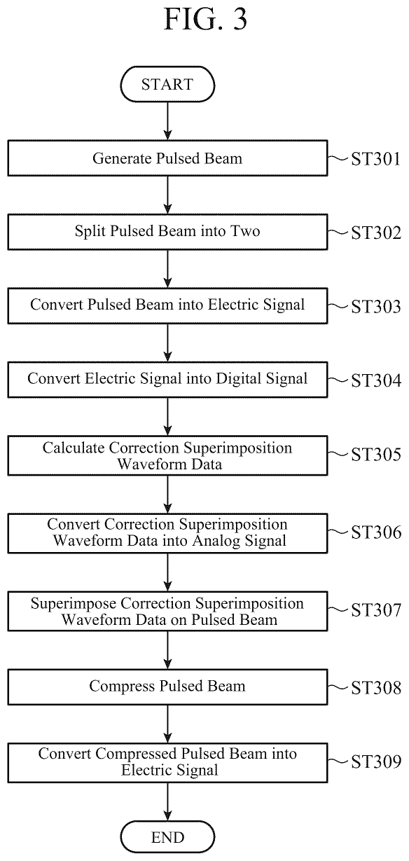

Next, an operation example of the waveform compression device according to the first embodiment depicted in FIG. 1 will be described with reference to FIG. 3.

In the operation example of the waveform compression device according to the first embodiment depicted in FIG. 1, as depicted in FIG. 3, the pulsed beam source unit 1 first generates a pulsed beam (Step ST301). Note that the intensity waveform of the pulsed beam generated by the pulsed beam source unit 1 is not an ideal rectangular waveform, and actually is a waveform with temporal fluctuations in pulses. The pulsed beam generated by the pulsed beam source unit 1 is output to the light distributor 2.

Next, the light distributor 2 splits the pulsed beam generated by the pulsed beam source unit 1 into two (Step ST302). A first pulsed beam split by the light distributor 2 is output to the light sensor 3, and a second pulsed beam is output to the light intensity modulator 7.

Next, the light sensor 3 converts the first pulsed beam split by the light distributor 2 into an electric signal (Step ST303). The electric signal obtained by the light sensor 3 is output to the ADC 4.

Next, the ADC 4 obtains sampling data of the pulsed beam by converting the electric signal obtained by the light sensor 3, which is an analog signal, into a digital signal (Step ST304). The electric signal resulting from the conversion by the ADC 4 is output to the correction superimposition waveform calculation unit 5.

Next, the correction superimposition waveform calculation unit 5 calculates correction superimposition waveform data on the basis of any superimposition waveform data and the electric signal resulting from the conversion by the ADC 4 (Step ST305). The correction superimposition waveform data calculated by the correction superimposition waveform calculation unit 5 is output to the DAC 6.

At this time, the data gate unit 501 first acquires, as pulse waveform data, data of a partial zone from the electric signal resulting from the conversion by the ADC 4.

Next, on the basis of the pulse waveform data acquired by the data gate unit 501, the minimum value sensing unit 502 senses the minimum value of the pulse waveform data.

Next, the data record unit 503 records the pulse waveform data acquired by the data gate unit 501, and data representing the minimum value of the pulse waveform data sensed by the minimum value sensing unit 502.

Next, the waveform calculation unit 504 calculates the correction superimposition waveform data on the basis of any superimposition waveform data, and the pulse waveform data and the data representing the minimum value of the pulse waveform data recorded in the data record unit 503. At this time, it is desirable if the waveform calculation unit 504 calculates the correction superimposition waveform data on the basis of modulation characteristics of the light intensity modulator 7.

Next, the DAC 6 converts the correction superimposition waveform data calculated by the correction superimposition waveform calculation unit 5, which is a digital signal, into an analog signal (Step ST306). The correction superimposition waveform data by the DAC 6 is output to the light intensity modulator 7.

Next, the light intensity modulator 7 obtains an intensity-modulated beam by superimposing the correction superimposition waveform data by the DAC 6 on the second pulsed beam split by the light distributor 2, and modulating the pulsed beam (Step ST307). The intensity-modulated beam obtained by the light intensity modulator 7 is output to the pulsed beam compression unit 8.

Next, the pulsed beam compression unit 8 obtains a compressed pulsed beam by compressing the pulsed beam modulated by the light intensity modulator 7 (Step ST308). The compressed pulsed beam obtained by the pulsed beam compression unit 8 is output to the light sensor 9.

Next, the light sensor 9 converts the compressed pulsed beam obtained by the pulsed beam compression unit 8 into an electric signal (Step ST309). Thereby, the waveform compression device can obtain a signal with a high frequency and a desired compressed pulse waveform. The electric signal obtained by the light sensor 9 is output to the outside of the waveform compression device.

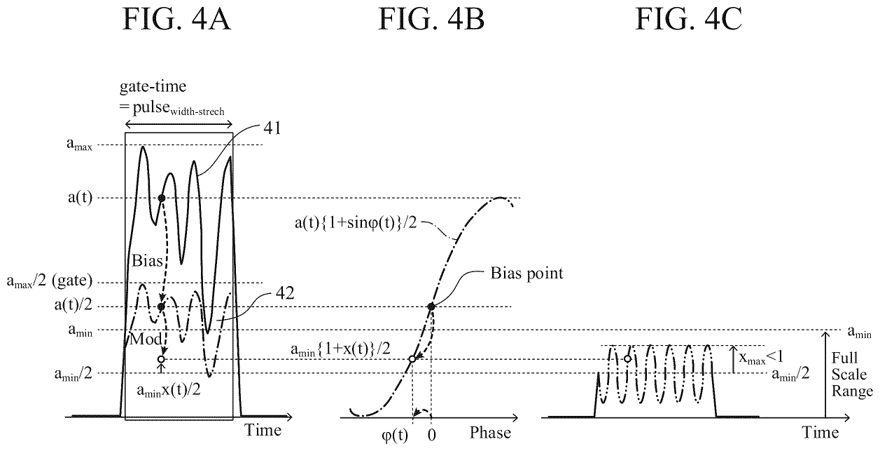

Next, a specific example of an operation performed by the correction superimposition waveform calculation unit 5 will be described with reference to FIGS. 4A to 4C. FIGS. 4A to 4C depict a case where the light intensity modulator 7 is an MZM, and a bias point of the MZM is the half-value of the maximum intensity of a pulsed beam input to the MZM. In addition, FIGS. 4A to 4C depict a case where the superimposition waveform data is data with a sine waveform.

First, FIG. 4A depicts an example of a pulsed beam input to the MZM and a pulsed beam biased by the MZM. In FIG. 4A, the reference sign 41 denotes the pulsed beam input to the MZM, and the reference sign 42 denotes the pulsed beam biased by the MZM. In addition, in FIG. 4A, the horizontal axis represents time, and the vertical axis represents intensity.

In addition, FIG. 4B depicts an example of modulation characteristics of the MZM. In FIG. 4B, the horizontal axis represents the phase difference between routes (arms) of an interferometer in the MZM, and the vertical axis represents intensity. Note that the phase difference is equivalent to the voltage value of the correction superimposition waveform data input to the MZM.

In addition, FIG. 4C depicts an example of an intensity-modulated beam obtained by the MZM. In FIG. 4C, the horizontal axis represents time, and the vertical axis represents intensity. That is, the MZM obtains the intensity-modulated beam as depicted in FIG. 4C by performing bias-control on the pulsed beam input to the MZM depicted in FIG. 4A in such a manner that the pulsed beam is biased to the half-value of the maximum intensity of the pulsed beam, and then performing intensity-modulation according to the correction superimposition waveform data input to the MZM and the modulation characteristics of the MZM.

Here, as depicted in FIG. 4A, temporal intensity fluctuations are generated in the pulsed beam input to the MZM. Accordingly, in a case where the intensity-modulation on the pulsed beam is performed in the MZM, the expressible range of the modulation waveform is constrained undesirably depending on the intensity fluctuations. For example, in the waveform denoted with the reference sign 41, while modulation is possible within a range to the maximum value at a point where the intensity exhibits the maximum value, modulation is possible only within a range to the minimum value at a point where the intensity exhibits the minimum value.

Accordingly, in a case where any superimposition waveform data is simply superimposed on such a pulsed beam, normal intensity-modulation cannot be performed over the entire zone of the pulsed beam in some cases, and there is a possibility that a distortion is generated in the waveform undesirably.

In addition, as depicted in FIG. 4B, the MZM does not have linear modulation characteristics, but has curved characteristics as represented by the following Formula (1). Accordingly, in the MZM, fluctuations of the voltage are not directly reflected in fluctuations of the intensity due to the modulation characteristics described above, and a distortion is generated.

Therefore, in the MZM, a harmonic distortion due to overmodulation is generated in a case where any superimposition waveform data is simply superimposed on the pulsed beam.

$$a ( t ) \{ 1 + sin ϕ ( t ) \} / 2 \qquad ( 1 )$$

In view of this, in the data gate unit 501 in the first embodiment, the correction superimposition waveform calculation unit 5 first acquires, as pulse waveform data, data of a partial zone from the electric signal resulting from the conversion by the ADC 4. That is, the data gate unit 501 acquires a zone equivalent to a zone where there is a possibility that an intensity fluctuation has been generated in the pulsed beam, from the electric signal resulting from the conversion by the ADC 4. In FIG. 4A, the gate width is approximately a pulse width, a timing at which it is assumed that the intensity of the pulsed beam has risen to the half-value of the maximum intensity is determined as the start point of a gate, and a timing thereafter at which it is assumed that the intensity of the pulsed beam has fallen to the half-value of the maximum intensity is determined as the end point of the gate. Note that, in FIG. 4A, aₘₐₓ denotes the maximum value of the pulse waveform data.

Next, on the basis of the pulse waveform data acquired by the data gate unit 501, the minimum value sensing unit 502 senses the minimum value of the pulse waveform data.

Then, the waveform calculation unit 504 calculates the correction superimposition waveform data on the basis of any superimposition waveform data, the pulse waveform data acquired by the data gate unit 501, and the minimum value of the pulse waveform data sensed by the minimum value sensing unit 502. At this time, it is desirable if the waveform calculation unit 504 calculates the correction superimposition waveform data on the basis of modulation characteristics of the light intensity modulator 7.

For example, the waveform calculation unit 504 calculates the correction superimposition waveform data according to the following Formula (2) on the basis of x(t), which is the superimposition waveform data, a(t), which is the pulse waveform data, aₘᵢₙ, which is the minimum value of the pulse waveform data, and the modulation characteristics of the MZM represented by Formula (1). Note that, in Formula (2), V (t) is the correction superimposition waveform data, and V_{π} is a half wavelength voltage.

$$V ( t ) = \frac{{V}_{π}}{π} Arc Sin \{ \frac{{a}_{min} ( 1 + x ( t ) )}{a ( t )} - 1 \} , wherein x ( t ) \leq 1 \qquad ( 2 )$$

That is, as depicted in FIG. 4C, the waveform calculation unit 504 calculates the correction superimposition waveform data so that the minimum value of the pulsed beam input to the MZM becomes the upper limit value of the full scale range of the pulsed beam resulting from the modulation by the MZM. Furthermore, the waveform calculation unit 504 calculates the correction superimposition waveform data so that a harmonic distortion generated by overmodulation in the MZM is suppressed, taking into consideration the modulation characteristics of the MZM. In the example depicted in FIG. 4C, the MZM finally can obtain an intensity-modulated beam having a distortion-free waveform with an offset of aₘᵢₙ/2, which is the half-value of the minimum value of the pulsed beam input to the MZM.

In this manner, the light intensity modulation device according to the first embodiment can reduce both a distortion caused by intensity fluctuations of the pulsed beam and a harmonic distortion caused by the light intensity modulator 7, by correcting the superimposition waveform data taking into consideration the minimum value of the pulse waveform data and the modulation characteristics of the light intensity modulator 7.

Note that the description above depicts, as an example, a case where the waveform calculation unit 504 performs calculation using an ArcSin function. However, the calculation method used by the waveform calculation unit 504 is not limited to this. The waveform calculation unit 504 may use not an ArcSin function, but another function expression that approximates the modulation characteristics of the light intensity modulator 7 such as, for example, linear approximation or polynomial approximation to perform calculation.

Here, calculation by the waveform calculation unit 504 using linear approximation is substantially equal to calculation of the correction superimposition waveform data without taking into consideration the modulation characteristics of the light intensity modulator 7.

In addition, it is not essential for the correction superimposition waveform calculation unit 5 to constantly acquire the pulse waveform data and the minimum value of the pulse waveform data. For example, in a case where it is assumed that intensity fluctuations of the pulsed beam are static or in another case, the correction superimposition waveform calculation unit 5 need not constantly acquire the pulse waveform data and the minimum value of the pulse waveform data, and, for example, it is sufficient if the correction superimposition waveform calculation unit 5 acquires the pulse waveform data and the minimum value of the pulse waveform data only once or at predetermined timings.

On the other hand, by repetitive acquisition of the pulse waveform data and the minimum value of the pulse waveform data by the correction superimposition waveform calculation unit 5, for example, it becomes to possible to cope with situations promptly even in a case where changes have occurred to intensity fluctuations of the pulsed beam due to ambient temperature fluctuations or ageing of devices.

In addition, for example, in a case where it is assumed that intensity fluctuations of the pulsed beam are static or in another case, the correction superimposition waveform calculation unit 5 may acquire the pulse waveform data and the minimum value of the pulse waveform data multiple times, record data representing a result obtained by averaging a plurality of pieces of the pulse waveform data, and a result obtained by averaging a plurality of minimum values, and use the data for the calculation of the correction superimposition waveform data. That is, the waveform calculation unit 504 may calculate the correction superimposition waveform data on the basis of a result obtained by averaging a plurality of pieces of data acquired by the data gate unit 501 and a result obtained by averaging the minimum values of the plurality of pieces of data sensed by the minimum value sensing unit 502, and the superimposition waveform data. Thereby, the correction superimposition waveform calculation unit 5 can enhance data acquisition precision.

In addition, the device disclosed in Patent Literature 1 requires the monitoring of the pulsed beam resulting from the shaping by the beam pulse shaping unit every time the target waveform changes.

In contrast to this, the light intensity modulation device according to the first embodiment does not require monitoring of the pulsed beam every time the superimposition waveform data changes. That is, the light intensity modulation device according to the first embodiment can calculate the correction superimposition waveform data using the pulse waveform data acquired in the past and the minimum value of the pulse waveform data even if the superimposition waveform data changes.

In addition, FIG. 2 depicts a case where the spectral shaping unit 102 is provided in the pulsed beam source unit 1. However, the spectral shaping unit 102 is not an essential component of the pulsed beam source unit 1, and may not be provided in the pulsed beam source unit 1.

In addition, FIG. 2 depicts a case where the MZM is used as the light intensity modulator 7. However, the light intensity modulator 7 is not limited to this. For example, an electrical-field-absorbing-type modulator may be used as the light intensity modulator 7.

In addition, it is sufficient if the wavelength dispersion unit 103 is a device that can give a different delay for each wavelength component. For example, a chirped fiber Bragg grating can be used as the wavelength dispersion unit 103.

Similarly, it is sufficient if the pulsed beam compression unit 8 is a device that can give a different delay for each wavelength component. For example, a chirped fiber Bragg grating can be used as the pulsed beam compression unit 8.

In addition, FIGS. 4A to 4C depict a case where the data gate unit 501 determines that the gate width is approximately a pulse width, a timing at which it is assumed that the intensity of the pulsed beam has risen to the half-value of the maximum intensity is the start point of a gate, and a timing thereafter at which it is assumed that the intensity of the pulsed beam has fallen to the half-value of the maximum intensity is the end point of the gate. However, this is not the sole example, and it is sufficient if the data gate unit 501 sets a gate in such a manner that a range where the correction superimposition waveform calculation unit 5 can monitor intensity fluctuations of the pulsed beam is acquired. Note that if the pulse waveform data acquired by the data gate unit 501 includes data of a time point before the pulsed beam rises or data of a time point after the pulsed beam falls, the minimum value sensing unit 502 undesirably senses, as the minimum value, a value of the data of the time point before the pulsed beam rises or a value of the data of the time point after the pulsed beam falls, and accordingly such data is prevented from being included.

In addition, whereas the minimum value sensing unit 502 senses the minimum value of the pulse waveform data in the description above, the minimum value need not be the minimum value in a strict sense, but may be slightly different from the minimum value.

In addition, the description above depicts a case where the waveform compression device simultaneously performs the suppression of a distortion caused by intensity fluctuations of the pulsed beam and the superimposition of any superimposition waveform data on the pulsed beam. However, this is not the sole example. The waveform compression device may separately perform the suppression of a distortion caused by intensity fluctuations of the pulsed beam and the superimposition of any superimposition waveform data on the pulsed beam.

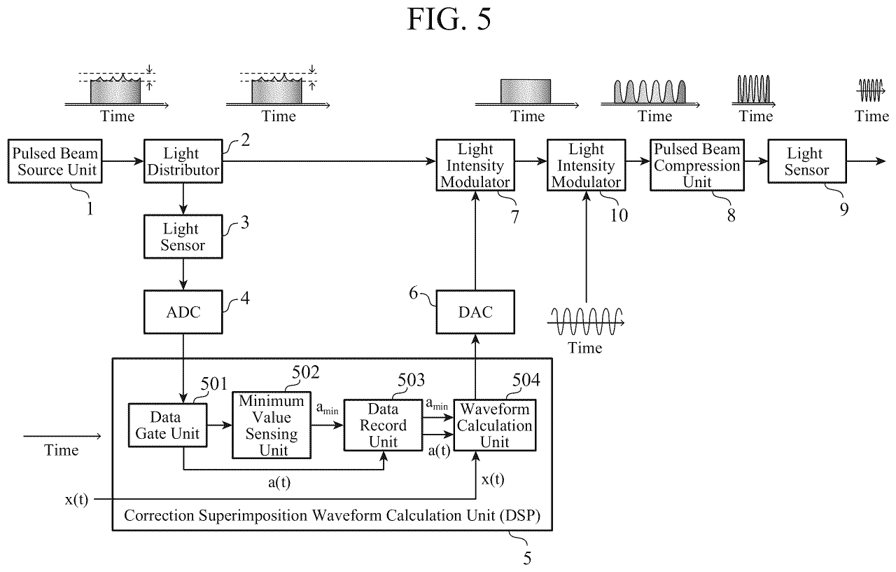

In this case, for example, as depicted in FIG. 5, the waveform compression device first performs the suppression of a distortion caused by intensity fluctuations of the pulsed beam using predetermined data (fixed value) as the superimposition waveform data, and thereafter performs the superimposition on the pulsed beam described above using any superimposition waveform data at a light intensity modulator 10. In addition, at this time, the waveform compression device may perform correction on the superimposition waveform data to be used at the light intensity modulator 10 in such a manner that a harmonic distortion is suppressed on the basis of modulation characteristics of the light intensity modulator 10, and then perform the superimposition.

In addition, the description above depicts a case where the light intensity modulation device according to the first embodiment is applied to the waveform compression device. However, a device to which the light intensity modulation device according to the first embodiment is applied is not limited to this. For example, the light intensity modulation device according to the first embodiment may be applied to a spectral analysis device to perform spectral analysis of a pulsed beam. It becomes possible for the spectral analysis device to perform highly-sensitive spectral analysis by being able to shape time intensity components of the pulsed beam to be used for the spectral analysis into any components.

As mentioned above, according to the first embodiment, the light intensity modulation device includes: the light distributor 2 to split a pulsed beam; the light sensor 3 to convert a first pulsed beam split by the light distributor 2 into an electric signal; the ADC 4 to convert the electric signal resulting from the conversion by the light sensor 3, which is an analog signal, into a digital signal; the correction superimposition waveform calculation unit 5 to calculate correction superimposition waveform data which is waveform data to correct a distortion due to a temporal intensity fluctuation of a pulsed beam on the basis of superimposition waveform data and the electric signal resulting from the conversion by the ADC 4; the DAC 6 to convert the correction superimposition waveform data calculated by the correction superimposition waveform calculation unit 5, which is a digital signal, into an analog signal; and the light intensity modulator 7 to obtain an intensity-modulated beam by superimposing the correction superimposition waveform data resulting from the conversion by the DAC 6 onto a second pulsed beam split by the light distributor 2. Thereby, as compared to conventional techniques, the light intensity modulation device according to the first embodiment can suppress a distortion in a modulation waveform of a pulsed beam even in a case where temporal fluctuations are generated in the intensity waveform of the pulsed beam. Furthermore, the light intensity modulation device according to the first embodiment can superimpose any waveform.

Note that modifications of any components in the embodiment or omissions of any components in the embodiment are possible.

### INDUSTRIAL APPLICABILITY

As compared to conventional techniques, the light intensity modulation device according to the present disclosure can suppress a distortion in a modulation waveform of a pulsed beam even in a case where temporal fluctuations are generated in the intensity waveform of the pulsed beam, and is suitable for being used for a light intensity modulation device or the like that performs intensity-modulation on a pulsed beam.

### REFERENCE SIGNS LIST

1: Pulsed beam source unit, 2: Light distributor, 3: Light sensor, 4: Analog-to-digital converter (ADC), 5: Correction superimposition waveform calculation unit (Correction superimposition waveform calculator), 6: Digital-to-analog converter (DAC), 7: Light intensity modulator, 8: Pulsed beam compression unit, 9: Light sensor (second light sensor), 101: Short pulsed beam source, 102: Spectral shaping unit, 103: Wavelength dispersion unit, 501: Data gate unit, 502: Minimum value sensing unit, 503: Data record unit, 504: Waveform calculation unit

1. A light intensity modulation device comprising:
a light distributor to split a pulsed beam;
a light sensor to convert a first pulsed beam split by the light distributor into an electric signal;
an analog-to-digital converter to convert the electric signal resulting from conversion by the light sensor, which is an analog signal, into a digital signal;
a correction superimposition waveform calculator to calculate correction superimposition waveform data which is waveform data representing any light intensity waveform, taking into consideration a distortion due to a temporal intensity fluctuation of a pulsed beam, on a basis of any superimposition waveform data and the electric signal resulting from conversion by the analog-to-digital converter, so that a value of the electric signal equivalent to a minimum value of the electric signal in a zone of the electric signal equivalent to a zone of the pulsed beam in which there is a possibility that a temporal intensity fluctuation has been generated in the pulsed beam, or an average value of a value of the electric signal equivalent to the minimum value becomes an upper limit value in a full-scale range of an intensity-modulated beam;
a digital-to-analog converter to convert the correction superimposition waveform data calculated by the correction superimposition waveform calculator, which is a digital signal, into an analog signal; and
a light intensity modulator to obtain an intensity-modulated beam having any waveform, by superimposing the correction superimposition waveform data resulting from conversion by the digital-to-analog converter onto a second pulsed beam split by the light distributor.

2. The light intensity modulation device according to claim 1, wherein the correction superimposition waveform calculator calculates the correction superimposition waveform data on a basis of modulation characteristics of the light intensity modulator.

3. The light intensity modulation device according to claim 1, wherein
the correction superimposition waveform calculator has:
a data gate acquirer to acquire data of a partial zone from the electric signal resulting from conversion by the analog-to-digital converter;
a minimum value sensor to sense a minimum value of the data acquired by the data gate acquirer; and
a waveform calculator to calculate the correction superimposition waveform data on a basis of the superimposition waveform data, the data acquired by the data gate acquirer, and the minimum value of the data sensed by the minimum value sensor.

4. The light intensity modulation device according to claim 3, wherein the data gate acquirer performs data acquisition every time an electric signal is converted by the analog-to-digital converter.

5. The light intensity modulation device according to claim 3, wherein the data gate acquirer performs data acquisition once or at a predetermined timing.

6. The intensity modulation device according to claim 3, wherein the waveform calculator calculates the correction superimposition waveform data on a basis of a result obtained by averaging a plurality of pieces of data acquired by the data gate acquirer and a result obtained by averaging minimum values of the plurality of pieces of data sensed by the minimum value sensor, and the superimposition waveform data.

7. A waveform compression device comprising:
a light distributor to split a pulsed beam;
a light sensor to convert a first pulsed beam split by the light distributor into an electric signal;
an analog-to-digital converter to convert the electric signal resulting from conversion by the light sensor, which is an analog signal, into a digital signal;
a correction superimposition waveform calculator to calculate correction superimposition waveform data which is waveform data representing any light intensity waveform, taking into consideration a distortion due to a temporal intensity fluctuation of a pulsed beam, on a basis of any superimposition waveform data and the electric signal resulting from conversion by the analog-to-digital converter, so that a value of the electric signal equivalent to a minimum value of the electric signal in a zone of the electric signal equivalent to a zone of the pulsed beam in which there is a possibility that a temporal intensity fluctuation has been generated in the pulsed beam, or an average value of a value of the electric signal equivalent to the minimum value becomes an upper limit value in a full-scale range of an intensity-modulated beam;
a digital-to-analog converter to convert the correction superimposition waveform data calculated by the correction superimposition waveform calculator, which is a digital signal, into an analog signal;
a light intensity modulator to obtain an intensity-modulated beam having any waveform, by superimposing the correction superimposition waveform data resulting from conversion by the digital-to-analog converter onto a second pulsed beam split by the light distributor;
a pulsed beam compressor to obtain a compressed pulsed beam by compressing the intensity-modulated beam obtained by the light intensity modulator; and
a second light sensor to convert the compressed pulsed beam obtained by the pulsed beam compressor into an electric signal.
